(19) United States
(12) Patent Application Publication
(10) Pub. No.: US 2011/0078327 A1
(43) Pub. Date: Mar. 31, 2011

(54) Content delivery utilizing multiple content delivery networks

(75) Inventors: Ming Li, Beijing (CN); Philip Lin, Hong Kong (CN); Chun Zhang, Shanghai (CN)

(73) Assignee: Prime Networks (Hong Kong) Limited

(21) Appl. No.: 12/587,016

(22) Filed: Sep. 30, 2009

(51) Int. Cl. G06F 15/16

(52) U.S. Cl. 709/238; 709/245

(57) ABSTRACT

Content delivery includes receiving a Domain Name Service (DNS) request, selecting from a plurality of Content Delivery Networks (CDNs) a CDN to provide content associated with the DNS request, processing the DNS request and generating a response, the response including a canonical name (CNAME) value that corresponds to the selected CDN, receiving an indication that the content is not presently available at the selected CDN, and returning an Internet Protocol (IP) address of a data source that is configured to provide the content to the selected CDN.

### BACKGROUND OF THE INVENTION

Website operators often use content delivery networks (CDNs) to improve the speed of content delivery to end users. A CDN typically includes a large number of computers for storing copies of website content. These storage computers, also referred to as cache nodes, are placed at various locations throughout the network. A client device attempting to access a website is directed to a copy of the website content that is located in close proximity to the client device to be quickly downloaded, thus improving the user's experience.

A number of CDN providers exist today. Given the overhead in switching subscriptions and setting up configurations, it can be difficult for a website operator to select among several CDN providers to get the best performance and the best rate.

### BRIEF DESCRIPTION OF THE DRAWINGS

Various embodiments of the invention are disclosed in the following detailed description and the accompanying drawings.

FIG. 1 is a network diagram illustrating an embodiment of a network environment.

FIG. 2 is a flowchart illustrating an embodiment of a process for delivering content.

FIG. 3 is a table illustrating an example of a content delivery session that takes place on network environment 100 of FIG. 1.

FIGS. 4A-4C are flowcharts illustrating several embodiments of CDN selection processes.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Content delivery using multiple CDNs is disclosed. In some embodiments, when a client makes a request for certain content of a website, a CDN manager overseeing the operations of the CDNs selects a suitable CDN and provisions a cache node in the selected CDN with content by using canonical name (CNAME) mapping.

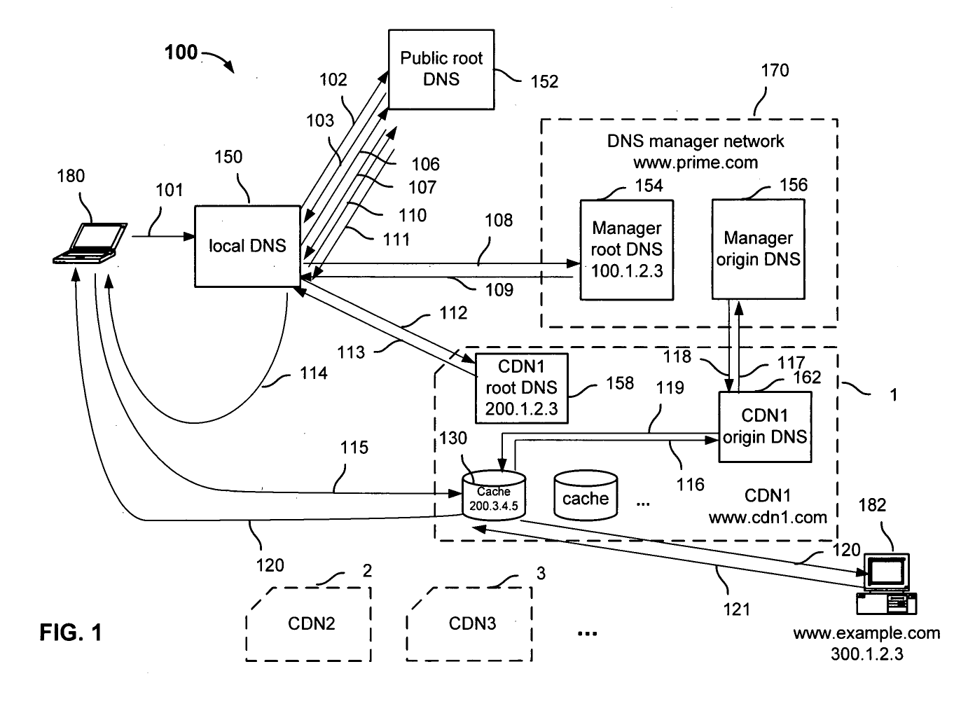

FIG. 1 is a network diagram illustrating an embodiment of a network environment. In this example, a client device 180, such as a computer, a mobile device, or any other device equipped with a communications interface, attempts to access content that is stored on a web server 182. For purposes of illustration, in the discussions below it is assumed that web server 182 belongs to the Internet domain “example.com”. For instance, the client device may be directed, in response to a user action on a web browser, to make a Hypertext Transfer Protocol (HTTP) GET request to retrieve a webpage on example.com. Since the content is originally stored on web server 182, this web server is also referred as the origin server.

A number of CDNs such as 1, 2, and 3 are available for caching the content on the origin server. For purposes of illustration, in the discussion below it is assumed that CDNs 1, 2, and 3 belong to domains “cdn1.com”, “cdn2.com”, and “cdn3.com”, respectively. Each CDN includes a number of cache nodes, such as 190 and 192, and one or more Domain Name Services (DNSes), such as 158 and 162 of CDN 1. In the example shown, DNS 158 is a root DNS configured to interact with the client device or the local DNS of the client device and DNS 162 is an origin DNS configured to locate the original content. The DNSes may be implemented as separate processes operating on one or more servers, different modules of a single process operating on a single server, or any other appropriate manner. The numbers of CDNs and cache nodes within the CDN are shown for purposes of example only and may vary for different network configurations.

The web server is a customer of CDN manager 170, which selects among the available CDNs a suitable CDN to provide caching functions of the content on the origin server. The CDN manager network includes a root DNS 154 configured to interact with the client device or its local DNS and an origin DNS 156 configured to locate the original content. For purposes of illustration, in the discussion below it is assumed that the CDN management network belongs to the domain “prime.com”.

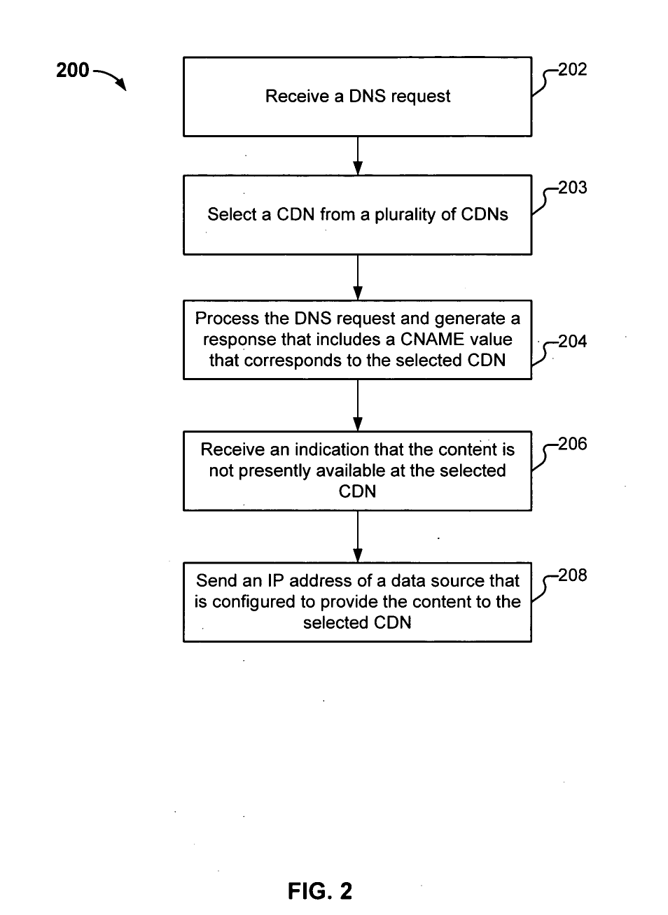

FIG. 2 is a flowchart illustrating an embodiment of a process for delivering content. Process 200 may be performed on a CDN manager network such as 170 of FIG. 1. At 202, a DNS request is received. In some embodiments, the DNS request corresponds to a request for an Internet Protocol (IP) address of a domain name that is a CNAME of the original domain name requested by the user.

A suitable CDN is selected from the available CDNs at 203. The selection techniques are described in greater detail below. At 204, the DNS request is processed and a response that includes a CNAME value that corresponds to the selected CDN is generated. In some embodiments, the CNAME value corresponds to a hostname on the selected CDN. Accordingly, upon receiving the response, the recipient (e.g., the local DNS) would redirect its requests for content to the selected DNS. Initially, the selected CDN is not configured to serve any web content associated with a DNS request since the content has not yet been cached. Thus, at 206, an indication that the content is not presently available at the selected CDN is received. This indication is sometimes referred as a cache miss indication. At 208, an IP address of a data source that is configured to provide the content to the selected CDN is sent, allowing content to be transferred from the data source (i.e., the origin server) to be copied to a cache node on the selected CDN and eventually be accessed by the user.

A full session beginning with the client's initial request, ending with the client downloading content from a selected CDN's cache node includes multiple exchanges. For purposes of example message exchanges are discussed in detail below, although any other appropriate techniques can also be used. Referring to FIG. 1, information exchanged between two nodes is illustrated using unique directional arrows. For example the arrow labeled 101 represents an exchange between the client device 180 and local DNS 150, where a message is sent from the client device to the local DNS. A variety of techniques can be used to implement the exchanges, such as DNS protocol based message exchanges or other appropriate messaging protocols.

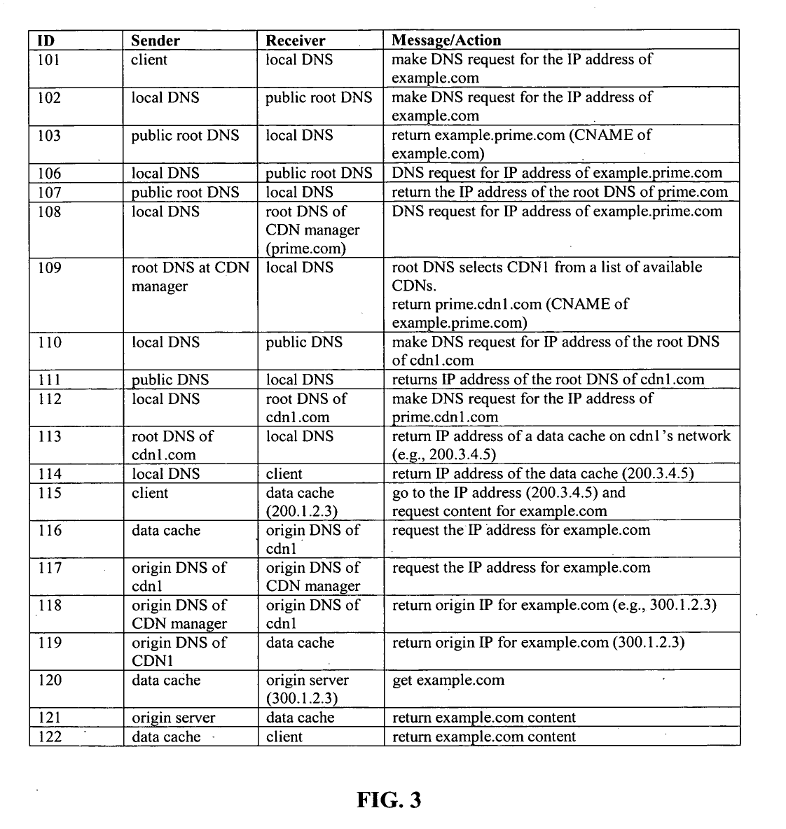

FIG. 3 is a table illustrating an example of a content delivery session that takes place on network environment 100 of FIG. 1. In FIG. 3, the label numbers of each exchange is listed in the ID column. For purposes of illustration, in this example, it is assumed that in each exchange a message is sent. Other types of exchanges are also possible in other embodiments. The corresponding message sender and receiver for each message communicated in the exchange are listed in the sender column and the receiver column, respectively. The message/action column indicates the content of the information that is sent by the sender to the receiver and the nature of any action that is taken. The entries in the table are discussed in detail below in connection with FIG. 1.

Messages 101-107 are generated as a part of a process that sends a DNS request to the CDN manager network. To access a desired webpage at www.example.com, the client sends its local DNS message 101, making a DNS request for the IP address of the domain name, i.e., example.com. At this point, the local DNS is not configured to resolve this domain name request. Thus, the local DNS sends a message 102 to public root DNS 152, making the same request for the IP address of example.com. The public root DNS is also not configured to resolve this domain name request down to an IP address; however, because the CDN manager network has registered itself with the public root DNS and previously added a CNAME entry mapping example.com to example.prime.com, the public root DNS returns to the local DNS the domain name of example.prime.com in message 103. The local DNS is still unable to resolve this domain name. It sends another DNS request 106 to the public root DNS, requesting the IP address of example.prime.com. The public root DNS is unable to provide this IP address, and returns instead the IP address of the root DNS for the CDN manager network prime.com (e.g., 100.1.2.3) in message 107, redirecting the local DNS to query the root DNS of prime.com for the IP address of example.prime.com.

The local DNS connects to the IP address of the root DNS of the CDN manager prime.com (e.g. 100.1.2.3) and makes a DNS request for the IP address of example.prime.com via message 108. Upon receiving the DNS request, the root DNS at the CDN manager selects a CDN from the list of available CDNs. Details of the selection technique are described more fully below. For purposes of illustration, it is assumed that in this example, CDN 1 is selected as the best suited CDN to service this request. To direct the local DNS and the client to CDN 1, the root DNS at the CDN manager sends a message 109 to the local DNS. The domain name of the selected CDN (i.e., cdn1.com) is combined with the second level domain name of the CDN manager network (i.e., prime) to form a CNAME value that corresponds to a hostname on the selected CDN and that is included in the message sent to the local DNS (in this case, prime.cdn1.com). The message indicates to the local DNS that prime.cdn1.com is a CNAME of example.prime.com and any request to example.prime.com should be redirected to prime.cdn1.com. Since the local DNS is not configured to directly resolve the IP address for prime.cdn1.com, it makes another request 110 to the public DNS for the IP address of the root DNS of the domain prime.cdn1.com. The public DNS is also not configured to directly resolve this domain name to IP address, but is configured to provide the IP address of the root DNS of cdn1.com (e.g., 200.1.2.3). Accordingly, the public DNS sends the IP address to the local DNS in message 111.

Upon receiving this IP address, the local DNS connects to the IP address of the root DNS of cdn1.com (e.g., 200.1.2.3) and makes a DNS request for the IP address of prime.cdn1.com in message 112. The root DNS of cdn1.com, based on its selection criteria such as geographic proximity or bandwidth availability, selects a suitable data cache for caching the content, and returns the IP address of the selected data cache to the local DNS in message 113. The local DNS forwards the information on to the client in message 114. For purposes of example, it is assumed that data cache 130 having an IP address of 200.3.4.5 is selected.

Upon receiving the IP address of the data cache, the client understands that the content it requested should be available at this IP address, and therefore connects to this IP address (200.3.4.5) and makes a request for the content of www.example.com, for example, as an HTTP GET request exchange 115. At this point, the data cache is not yet configured to serve content associated with the DNS request of www.example.com, in other words, the content is not yet stored on the data cache. A cache miss results. Upon experiencing a cache miss, the data cache is configured to ask the origin DNS of CDN 1 for the origin IP of www.example.com in message 116. The origin DNS of CDN 1, being configured forward the IP address request to the origin DNS of the CDN manager, asks the origin DNS of the CDN manager for the IP address of www.example.com in message 117.

The origin DNS or the CDN manager, being configured to resolve the domain name of www.example.com to its corresponding IP address (e.g., 300.1.2.3), returns the origin IP address for www.example.com to origin DNS of CDN 1 via message 118. The origin DNS of CDN 1 passes the origin IP for www.example.com to the data cache in message 119. Since the CDN manager's origin DNS is responsible for resolving the domain name of the client's original request for a customer's domain name, only the CDN manager's origin DNS needs to be configured and no additional configuration for the customer is required on the part of the individual CDNs.

The data cache connects to the origin server's IP address, making a request for the web content of www.example.com in message 120. In message 121, the origin server returns the content of www.example.com to the data cache. In message 122, the data cache sends the content of www.example.com to the client and the session is completed. The content stored in the data cache is accessible for a period of time. If no further access is made to the content after a timeout period, the content may be deleted from the data cache.

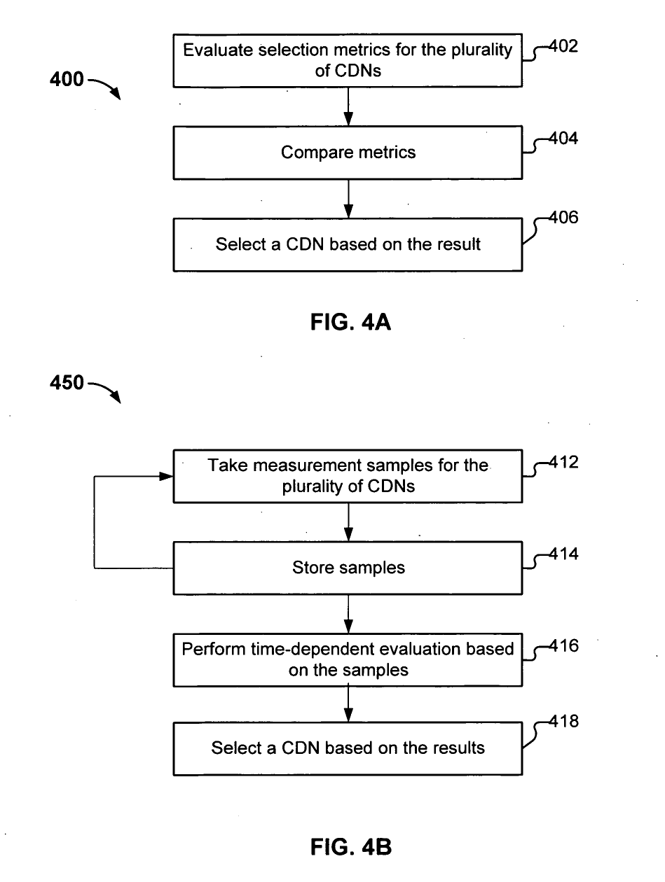

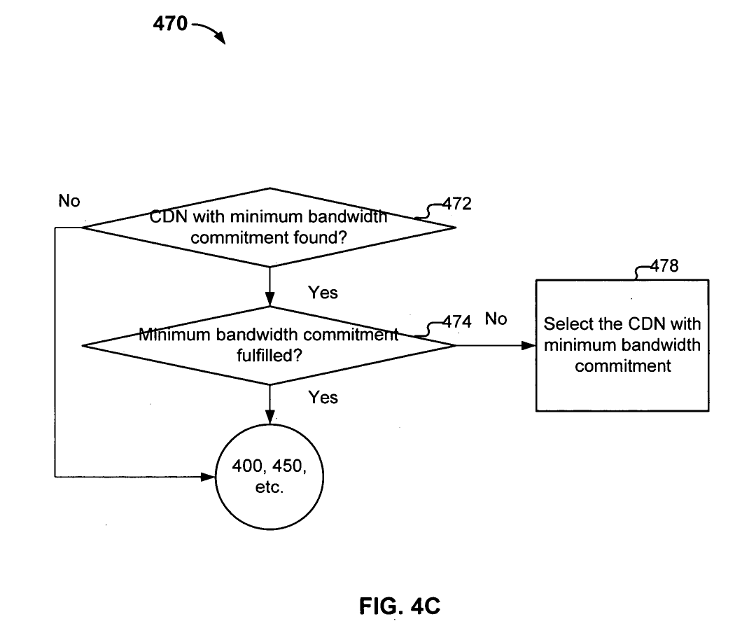

A variety of techniques can be used by the CDN manager to make the CDN selection. FIGS. 4A-4C are flowcharts illustrating several embodiments of CDN selection processes. In FIG. 4A, performance of the CDNs are monitored and certain selection metrics are evaluated at 402. In some embodiments, the selection metric includes one or more performance metrics such as the response time for an HTTP request by each CDN, the bandwidth available at each CDN, performance feedback measured by a third party that places probes on the network, etc. In some embodiments, the performance metrics are based on performance feedback sent by the CDNs, such as real time access information of a specific website by users serviced by different CDNs. In some embodiments, the CDNs charge different rates and the rate of each CDN may vary depending on time of the day, bandwidth availability, etc. Thus, the selection metric includes the cost of the transaction for each CDN. In some embodiments, the selection metric includes the availability of DNS servers on the CDNs. In some cases, to determine the availability of DNS servers on the CDNs, the local DNS servers in a specified region are monitored to determine the number (or percentage) of local DNS servers that have correctly resolved the CDN's cname. Other appropriate selection metrics can be used as well. In some embodiments, the selection metric is a value computed based on a number of different types of metrics, weighted according to the a formula such as

$$M = \frac{1}{n} {\sum }_{i = 1}^{n} {w}_{i} {m}_{i} ,$$

where n corresponds to the number of metrics, w corresponds to the weight for each metric, and m corresponds to the value of the metric. Other formulas may be used as well, including complex multi-step formulas that require several computation iterations. The metrics or predictions computed based on the metrics, are compared at 404. At 406, a CDN is selected based on the result of the evaluation and comparison.

FIG. 4B illustrates an embodiment of a time-dependent CDN selection process. At 412, measurement samples for the CDNs are taken. In various embodiments, the measurement samples comprise response time, cost, CNS server availability, and/or other appropriate measurements taken at a specific point in time. At 414, the samples are stored. After a certain amount of time, another set of measurements are taken and stored. 412 and 414 are repeated until a required time series of samples are accumulated. For example, a set of measurements are taken every 6 minutes over a 2 hour period to produce 20 sets of measurement samples that are used for evaluation.

At 416, a time dependent evaluation based on the samples is performed. The evaluation is said to be time dependent since the samples are collected over a period of time. In some embodiments, the evaluation is based on a function that determines the average or mean value of the sample set for each CDN. In some embodiments, the evaluation is based on a weighted function that gives different weights to the samples in each sample set; for example, more recent samples are given greater weights than more distant samples. In some embodiments, the evaluation is based on a function that computes the standard deviations of each sample sets, where a low standard deviation indicates that the CDN has more stable performance. The standard deviations may be combined with other metrics such as response time, cost, etc. to determine a score for selecting a CDN that has better overall stability and performance. In some embodiments, the evaluation includes computing the time-dependent function multiple times, each time based on a different subset of the measurements and taking an average or weighted average of the results.

In some embodiments, a pre-selection criterion is applied before any metrics are evaluated. FIG. 4C illustrates an embodiment of a CDN selection process where a pre-selection criterion is used. In this example, a web site operator may have a service agreement with a certain CDN that requires a minimum bandwidth commitment. In this example, at 472, it is determined whether a CDN with a minimum bandwidth commitment is found among the available CDNs. If so, at 474, it is determined whether the minimum bandwidth commitment has been fulfilled already. If the commitment has not been fulfilled yet, at 478, the CDN with the minimum bandwidth commitment is selected so that bandwidth used for this transaction will count towards fulfilling the requirement. If no CDN has any minimum bandwidth requirement, or if the requirement has already been fulfilled, the process will carry out CDN selection in a manner similar to what was shown in process 400 or 450.

Although the above example shows pre-selection based on a minimum bandwidth commitment, other pre-selection criteria may also be used to pre-select one or more CDNs from the available CDNs. In some embodiments, the capacity limit associated with one or more CDNs may be used. For example, the CDN manager may purchase differing amounts of capacity from different CDNs to achieve cost savings. If, for instance, at 2 pm, CDN 1 offers 100 Mb/s of bandwidth at a price of X, while CDN 2 and CDN 3 are each offering the same bandwidth at a price of 2×, the CDN manager may choose to purchase most of its required capacity at 2 pm from CDN 1 and limited amount or none at all from CDNs 2 and 3. If, while processing a request at 2 pm, during pre-selection it is determined that the capacity limit of CDN 2 or 3 has been exceeded or is about to be exceeded, such CDNs may be prevented to service the request and all the traffic is directed to CDN 1, which has ample capacity.

Content delivery utilizing multiple CDNs has been described. By employing a CDN manager network that selects among the CDNs, website owners can provide better end user experience and achieve cost savings.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for delivering content, comprising:
one or more processors configured to:
receive a Domain Name Service (DNS) request;
select from a plurality of Content Delivery Networks (CDNs) a selected CDN to provide content associated with the DNS request;
process the DNS request and generate a response, the response including a canonical name (CNAME) value that corresponds to the selected CDN;
receive an indication that the content is not presently available at the selected CDN; and
return an Internet Protocol (IP) address of a data source that is configured to provide the content to the selected CDN; and
a memory coupled to the processor, configured to provide the processor with instructions.

2. The system of claim 1, wherein the processor is further configured to receive the content from the data source and store the content in a data cache that is a part of the selected CDN.

3. The system of claim 1, wherein the CNAME value corresponds to a hostname associated with the selected CDN.

4. The system of claim 1, wherein selecting the selected CDN from the plurality of CDNs includes monitoring performance of the plurality of CDNs.

5. The system of claim 1, wherein selecting the selected CDN from the plurality of CDNs includes evaluating a selection metric.

6. The system of claim 5, wherein the selection metric includes DNS availability of the plurality of CDNs.

7. The system of claim 5, wherein the selection metric includes bandwidth availability associated with the plurality of CDNs.

8. The system of claim 5, wherein the selection metric includes performance feedback by the plurality of CDNs.

9. The system of claim 5, wherein the selection metric includes performance feedback measured by a third party.

10. The system of claim 1, wherein selecting the selected CDN includes evaluating a time-dependent function.

11. The system of claim 10, wherein the time-dependent function is computed based on sample sets associated with the plurality of CDNs over a period of time.

12. The system of claim 10, wherein the time-dependent function is used to compute averages or mediums of the plurality of CDNs over a period of time.

13. The system of claim 10, wherein the time-dependent function is used to compute standard deviations of sample sets associated with the plurality of CDNs over a period of time.

14. The system of claim 10, wherein the time-dependent function includes a weighted function.

15. The system of claim 10, wherein evaluating the time-dependent function includes computing the time-dependent function multiple times.

16. The system of claim 1, wherein selecting the selected CDN from the plurality of available CDNs includes applying a pre-selection criterion.

17. The system of claim 16, wherein the pre-selection criterion includes a minimum bandwidth commitment level associated with at least some of the plurality of CDNs.

18. The system of claim 16, wherein the pre-selection criterion includes capacity limit associated with at least some of the plurality of CDNs.

19. A method of delivering content, comprising:
receiving a Domain Name Service (DNS) request;
selecting from a plurality of Content Delivery Networks (CDNs) a selected CDN to provide content associated with the DNS request;
processing the DNS request and generating a response, the response including a canonical name (CNAME) value that corresponds to the selected CDN;
receiving an indication that the content is not presently available at the selected CDN; and
returning an Internet Protocol (IP) address of a data source that is configured to provide the content to the selected CDN.

20. A computer program product for delivering content, the computer program product being embodied in a computer readable storage medium and comprising computer instructions for:
receiving a Domain Name Service (DNS) request;
selecting from a plurality of Content Delivery Networks (CDNs) a selected CDN to provide content associated with the DNS request;
processing the DNS request and generating a response, the response including a canonical name (CNAME) value that corresponds to the selected CDN;
receiving an indication that the content is not presently available at the selected CDN; and
returning an Internet Protocol (IP) address of a data source that is configured to provide the content to the selected CDN.
